(19) United States
(12) Patent Application Publication
(10) Pub. No.: US 2012/0254208 A1
(43) Pub. Date: Oct. 4, 2012

(54) SIGNATURE IDENTIFICATION AND DISTRIBUTION

(75) Inventor: Herbert Duvoisin, III, Orlando, FL (US)

(73) Assignee: L-3 COMMUNICATIONS CYTERRA CORPORATION, Orlando, FL (US)

(21) Appl. No.: 13/410,617

(22) Filed: Mar. 2, 2012

Related U.S. Application Data
(60) Provisional application No. 61/448,883, filed on Mar. 3, 2011.

(51) Int. Cl. G06F 17/30

(52) U.S. Cl. 707/758; 707/E17.014

(57) ABSTRACT

A device includes a sensing element configured to produce a representation of an object in a space near the sensing element, an electronic storage comprising multiple representations, each representation being associated with a particular object, a communications interface, and a processor operable to receive the representation of the object in the space from the sensing element, compare the representation of the object in the space to the multiple representations stored in the electronic storage, determine that the representation of the object in the space is different from all of the multiple representations based on the comparison, identify the representation as a new representation based on the determination, and cause the new representation to be available to a data site through the communications interface. The device also may obtain a new representation from the data site.

### CROSS-REFERENCE TO RELATED APPLICATION

This application claims priority from U.S. Provisional Application No. 61/448,883, filed Mar. 3, 2011, and titled “SIGNATURE IDENTIFICATION AND DISTRIBUTION,” which is incorporated by reference.

### TECHNICAL FIELD

This description relates to signature identification and distribution.

### BACKGROUND

A sensor is used to detect objects positioned in the environment near the sensor, and that data may be used to determine a signature of the detected object.

### SUMMARY

In one general aspect, a device includes a sensing element configured to produce a representation of an object in a space near the sensing element, an electronic storage comprising multiple representations, each representation being associated with a particular object, a communications interface, and a processor operable to receive the representation of the object in the space from the sensing element, compare the representation of the object in the space to the multiple representations stored in the electronic storage, determine that the representation of the object in the space is different from all of the multiple representations based on the comparison, identify the representation as a new representation based on the determination, and cause the new representation to be available to a data site through the communications interface.

Implementations may include one or more of the following features. Each of the multiple representations may be a signature of a particular hazardous object. Each of the signatures may uniquely identify the particular hazardous object. The sensing element may be configured to detect metallic objects. The sensing element may include a radar. The sensing element may include multiple sensing elements. Each of the multiple sensing elements may be a different type of sensing element. The multiple sensing elements may include a ground penetrating radar and a sensor configured to detect metallic objects. The sensing element may be mounted in a fixed screening portal. The sensing element may be configured to detect metallic objects hidden on an item moving through the portal, the item being one or more of a person or a package. The sensing element may be mounted on a movable platform. The sensing element may be mounted on a hand-held platform. The processor included in the device may be further operable to identify the new representation as a signature of a previously unknown hazardous object. The processor included in the device may be further operable to access a representation of a previously unknown object from the data site through the communications interface, store the representation of the previously unknown object in the electronic storage, compare the representation of the object in the space to the representation of the previously unknown object, determine whether the object in the space is the previously unknown object based on the comparison, and store the representation of the object in the electronic storage if the object in the space is not the previously unknown object.

In another general aspect, a device includes a sensing element configured to produce a representation of an object in a space near the sensing element, an electronic storage, a communications interface, and a processor operable to access a representation of a previously unknown object from the data site through the communications interface, store the representation of the previously unknown object in the electronic storage, compare the representation of the object in the space to the representation of the previously unknown object, determine whether the object in the space is the previously unknown object based on the comparison, and store the representation of the object in the electronic storage if the object in the space is not the previously unknown object.

Implementations may include one or more of the following features. The processor may be further operable to detect a notification indicating that a previously unknown object has been identified and that a representation of the previously unknown object is available from a data site, and the processor may access the representation of the previously unknown object from the data site through the communications interface in response to detecting the notification. The device may further include an indicator that presents an alarm if the object in the space is the previously unknown object. The processor included in the device may be further operable to determine that the representation of the object in the space is different from all stored multiple representations based on the comparison, identify the representation of the object in the space as a new representation based on the determination, and cause transmission of the new representation through the communications interface.

In another general aspect, a computer-readable storage medium stores instructions, that when executed, cause a processor to receive a signature from a device, the signature being identified as being a representation of a previously unknown object by the device, store the signature received from the device, generate a notification indicating that a signature of a previously unknown device is available, and provide the signature to a notified device in response to receiving a request from the notified device.

Implementations may include one or more of the following features. The device and the other device may be two different types of detectors. The device and the other device each include a different type of detector. The instructions may further cause the processor to display a user interface that allows visualization of stored signatures.

Implementations of any of the techniques described above may include a method, a process, a system, a device, an apparatus, or instructions stored on a computer-readable storage medium. The details of one or more implementations are set forth in the accompanying drawings and the description below. Other features will be apparent from the description and drawings, and from the claims.

### DESCRIPTION OF THE DRAWINGS

FIG. 1A shows an example system used for detecting objects.

FIG. 1B shows an example of a signature of an object detected by the system of FIG. 1A.

FIG. 2 shows the system of FIG. 1A sending the signature of the object to a data site.

FIG. 3 shows the data site of FIG. 2 providing the signature to another example system for detecting hazardous objects.

FIG. 4 shows a block diagram of an example device used for detecting hazardous objects.

FIG. 5 shows an example of a process for real-time signature identification and distribution.

FIG. 6 shows an example of a process for real-time signature distribution.

FIG. 7 shows an example hand-held system for detecting objects.

### DETAILED DESCRIPTION

Techniques for identifying and distributing signatures of detected objects are disclosed. In some prior systems, data is collected from a training set of objects that includes known clutter (benign or background) objects and known target (threat) objects. The collected data is subsequently analyzed. The analyzed data is used to train a classifier. The trained classifier is placed on a detection or screening system such that when the system encounters an object during use, the classifier determines whether the encountered object is one of the clutter or target objects included in the training set.

However, certain individuals (for example, terrorists and others wishing to cause harm) may modify or hide threat objects, such as contraband, weapons, drugs, bulk currency, stolen items, and/or explosives in unexpected ways in order to avoid detection by existing classifiers. For example, such classifiers may face challenges when encountering a new threat object that was not included in the training data or a new threat object that is a modified version of a threat object included in the training data. Thus, wrong-doers may attempt to defeat such classifiers by modifying known threat objects or by introducing new threat objects. Further, terrorists and others may introduce new weapons in an attempt to cause more harm. A new weapon may be a hazardous object such as a new explosive device, an explosive having chemical properties different from commonly known explosives, a knife or other weapon made of a new material, or a weapon that is hidden in an unexpected medium (such as an incendiary device hidden on or in a person or under the clothing or footwear of the person). As a result of the changing threat object landscape, some prior classifiers may classify a previously unknown target as a clutter object incorrectly, and this misclassification may lead to harm to persons and equipment. Thus, a system that adapts to changing threats may provide performance, reliability, and safety advantages over a system that does not adapt to changing threats.

The techniques discussed below may address these challenges by identifying signatures of new, or not previously encountered, threat objects in real-time, or near real-time. For example, the techniques discussed below include determining a signature of an object detected by a sensor, and comparing the signature to one or more signatures that are known to represent a particular threat object. If the determined signature does not match any of the known signatures, then the signature of the detected object is deemed to be a new signature that represents a previously unknown object, perhaps a new threat object. The new signature is shared with other sensors in real time, or near real time, such that the other sensors may identify the previously unknown object as a threat object when the other sensors encounter the new threat. In this manner, the techniques discussed below may allow the other sensors to react more quickly to changing threats.

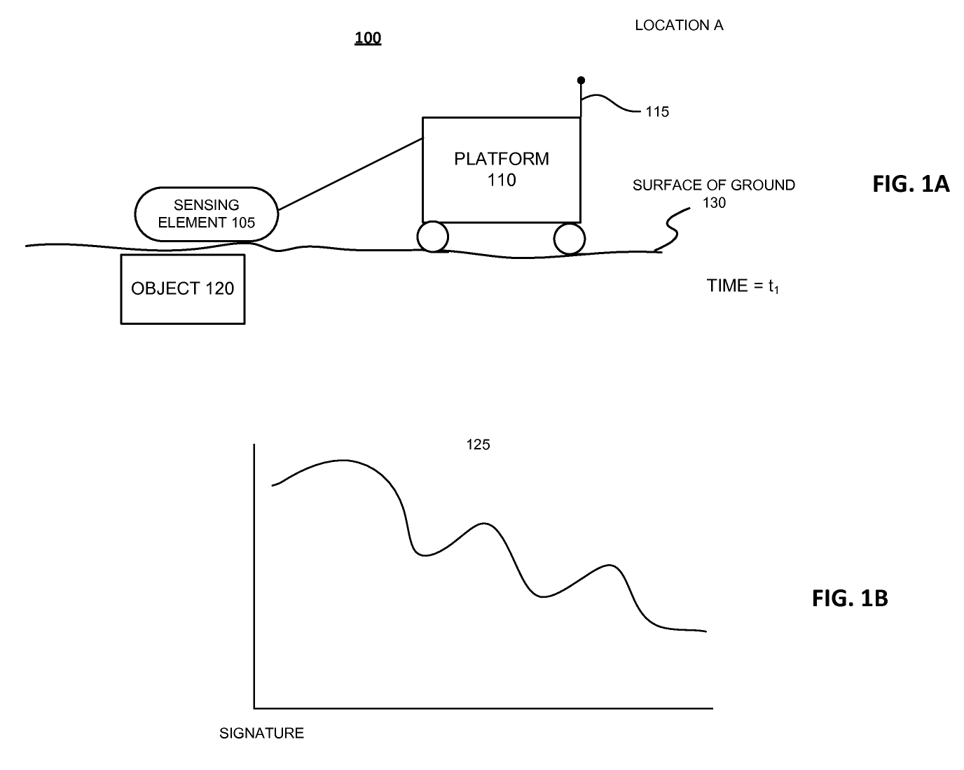

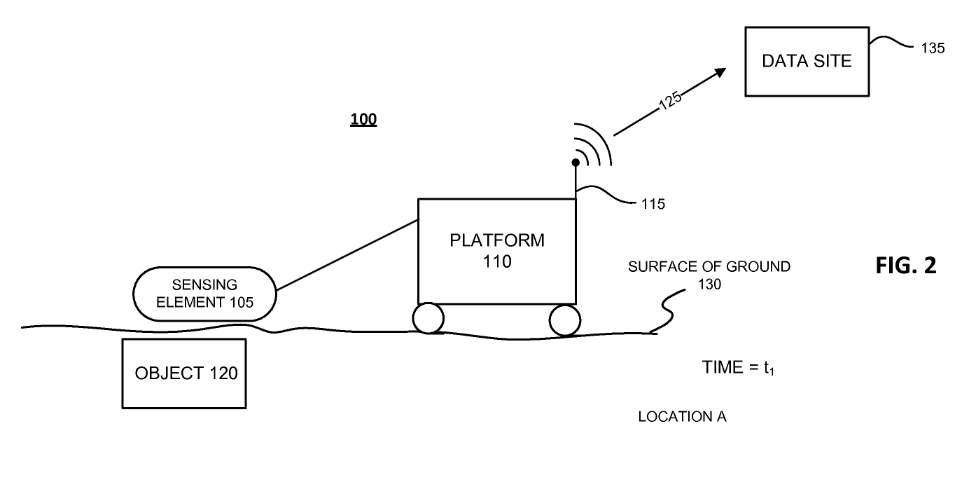

Referring to FIG. 1A, a system 100 for detecting threat objects includes a sensing element 105 attached to a platform 110. The system 100 also includes a communications interface 115. In the example shown, the system 100 is positioned such that the sensing element 105 is positioned near a previously unknown or never-before-encountered threat object 120. The sensing element 105 detects the object 120 and the system 100 determines a signature 125 (FIG. 1B) of the detected object 120 based on data from the sensing element 105. The signature 125 is provided to a data site 135 (FIG. 2) through the communications interface 115.

In the example shown, the threat object 120 is a previously unknown or never-before-encountered object, such as a buried explosive, that is detonated when a sufficient amount of pressure is applied to the object. However, the previously unknown threat object 120 may be any hazardous, potentially hazardous, or other type of contraband object that has not been previously detected by the sensing element 105. The threat object 120 may be an object that has an identifying signature that is not included in a library of signatures of known threat objects. For example, the previously unknown threat object 120 may be a surface explosive, a trace amount of a chemical, or a weapon hidden in the body of a person.

In FIG. 1A, the sensing element 105 is a sensor that produces ground-penetrating radiation and detects objects buried under, in, or on a surface, such as ground surface 130. For example, the sensing element 105 may be a metal detector, a ground-penetrating radar, or both. However, the sensing element 105 may be any sensor or detector that senses an environment around the sensor or detector and produces data that represents the environment around the sensor. For example, the sensing element 105 may be a continuous-wave metal detector (CWMD), a trace detector that detects chemical residue associated with explosives, a millimeter-wave radar, an induction detection system, a taggant detection system, a dielectric detector, a system that generates and detects x-rays, an imaging sensor (such as a visible or infrared camera), or a radar that penetrates walls and other barriers.

In the example shown, the platform 110 on which the sensing element 105 is mounted is a movable platform that allows the sensing element 105 to scan a particular area when the platform 110 is stationary or when the platform 110 is moving. In other examples, the platform 110 may be a fixed platform such as a screening portal through which persons, packages, or vehicles pass or a platform (such as a wand) that allows a human operator to hold and operate the sensing element 105. The platform 110 may be a movable portal that scans persons, packages, or vehicles.

Referring to FIG. 2, the system 100 is shown transmitting the signature 125 (or data representing the signature) to the data site 135 through the communications interface 115. The data site 135 may be a remote data site that is, for example, a computer that is separate from the system 100 but in communication with the system 100 through the communications interface 115.

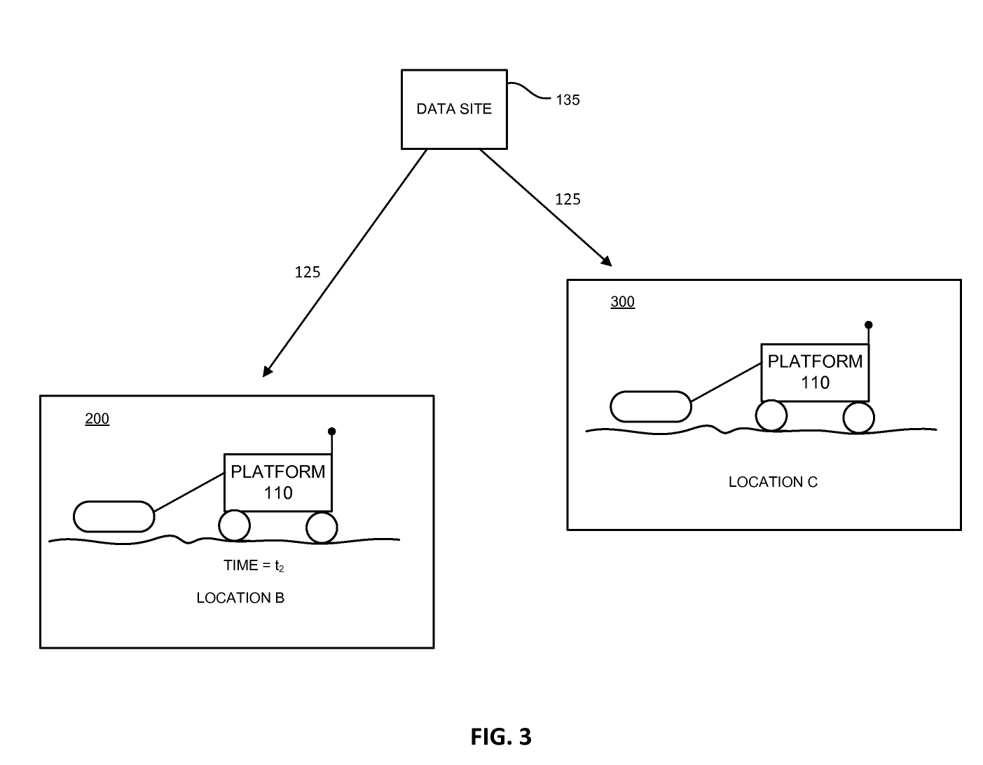

Referring to FIG. 3, the data site 135 is shown transmitting the signature 125 to two other example systems, systems 200 and 300. The systems 200 and 300 are in locations B and C, respectively, both of which are different locations than the location of system 100 (location A). Transmitting the signature 125 to the systems 200 and 300 allows the systems 200 and 300 to apply the signature 125 (which represents a previously unknown threat object) to data collected by the systems 200 and 300. In some implementations, the locations B and C of systems 200 and 300 are relatively distant from the location A of system 100. For example, the locations A, B, and C and respective systems 100, 200, and 300 may be hundreds or thousands of miles apart from each other. However, the systems 200 and 300 may be in the same general vicinity as the system 100. For example, the systems 100, 200, and 300 may be located in the same airport.

In the example shown in FIGS. 2 and 3, the system that provides the signature (the system 100) and the systems that receive the signature 125 (the systems 200 and 300) are similar systems with similar or identical sensing elements. For example, the system 100 may include a wide band radar that provides a signature 125 based on signals detected with the radar. The systems 200 and 300 may include a radar that has a narrower band than the radar of the system 100. However, the signature produced for a given object detected by the system 100 and the systems 200 and 300, though slightly different, may be similar enough that signatures identified by system 100 may be interpreted by the systems 200 and 300 to determine whether the same given object is detected by system 200 or 300. As such, the signature 125 may be used by or with the systems 200 and 300. Similarly, a signature detected by and/or determined from data from the system 200 or 300 may be used in conjunction with the system 100.

In some implementations, the systems 100, 200, and 300 may each be equipped with similar radars that have the same bandwidth but include different frequencies within the bandwidth. For example, each of the systems 100, 200, and 300 may include a radar having a 500 GHz bandwidth. The radar of the system 100 may include 256 frequencies within the 500 GHz bandwidth, while the systems 200 and 300 include 128 frequencies. In this instance, a signature of a given object from the system 100 may be used in the systems 200 and 300 and vice versa.

As yet another example, each of the systems 100, 200, and 300 may include a sensor, such as a continuous wave metal detector (CWMD) that produce data from which amplitude and frequency vectors representing a detected object may be extracted. In this example, the signatures produced by the systems 100, 200, 300 may be shared among the three systems. As a result, the signature 125 provided by the system 100 may be appropriate for use with systems 200 and 300.

Although the above examples discuss providing signatures to systems that include a sensor that is similar, but not identical, to the sensor that initially detected the potential new threat object, in some examples, the signature 125 may be provided to systems that have a different type of sensing element, or multiple different types of sensing elements.

The system 100 (FIG. 1) determines the signature at a time=t₁, and the system 300 accesses and the signature at a time=t₂. The times t₁ and t₂ may be separated by less than a minute, less than an hour, or less than a day to allow the system 300 to begin screening for the new threat quickly. In some implementations, the data site 135 provides regular downloads or regularly pushes new signatures to all of the systems 100, 200, and 300 that are in communication with the data site 135. The downloads or updates may occur, for example, on a daily or hourly basis.

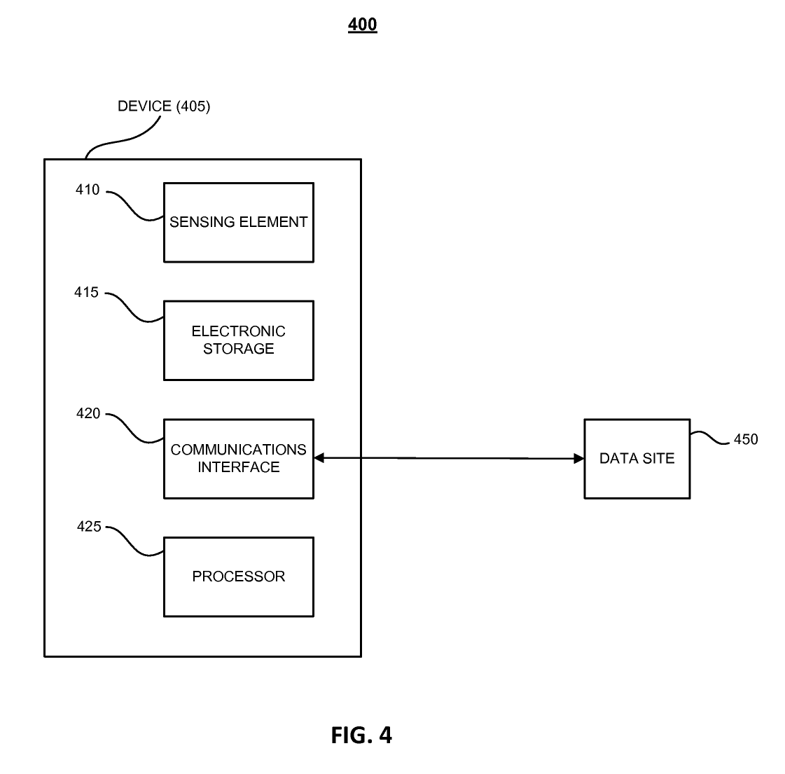

FIG. 4 shows a block diagram of a device 405 in communication with a data site 450. The device 405 includes a sensing element 410, an electronic storage 415, a communications interface 420, and a processor 425. The device 405 may be similar to the systems 100, 200, and 300 discussed above. The communications interface 420 provides a data connection between the device 405 and the data site 450.

The sensing element 410 may be any sensor or detector that senses an environment or space around the sensor or detector and produces data that represents the environment or space. For example, the sensing element 410 may be a continuous-wave metal detector (CWMD), a trace detector that detects chemical residue associated with explosives, a millimeter-wave radar, a radar that produces electromagnetic radiation capable of penetrating walls and other barriers, an optical sensor, an acoustic sensor, or a chemical sensor. The sensing element 410 may include more than one sensing element, and each of the multiple sensing elements may be different from each other. For example, the sensing element may include a ground-penetrating radar and a metal detector. The multiple sensing elements may be the same type of sensor.

The device 400 also includes an electronic storage 415, a communications interface 420, and a processor 425. The electronic storage 415 stores instructions, perhaps as a computer program, that, when executed, cause the processor 425 to process data from the sensing element 410 and to determine whether the data detected by the sensing element 410 represents a detection of a previously unknown object. The electronic storage 415 also stores instructions that cause the communications interface to interact with the data site 450. The electronic storage 415 also may store a library of signatures that are known to represent a particular threat object. The electronic storage 415 may be volatile memory, such as RAM. In some implementations, and the electronic storage components 415 may include both non-volatile and volatile portions or components. The processor 425 may include one or more processors suitable for the execution of a computer program such as a general or special purpose microprocessor, and any one or more processors of any kind of digital computer. Generally, a processor receives instructions and data from a read-only memory or a random access memory or both.

The communications interface 420 may be, for example, a data port that allows data to be read from or written to the electronic storage 415. The communications interface 420 may include an element that transmits and receives data over a wireless connection, such as a Wi-Fi connection. The communications interface 420 may be any interface that allows communication with the device 405, either through a physical connection or a wireless connection.

Although the components of the device 405 are shown together and are in communication with each other, the components of the device 405 may be housed separately or in a single unit.

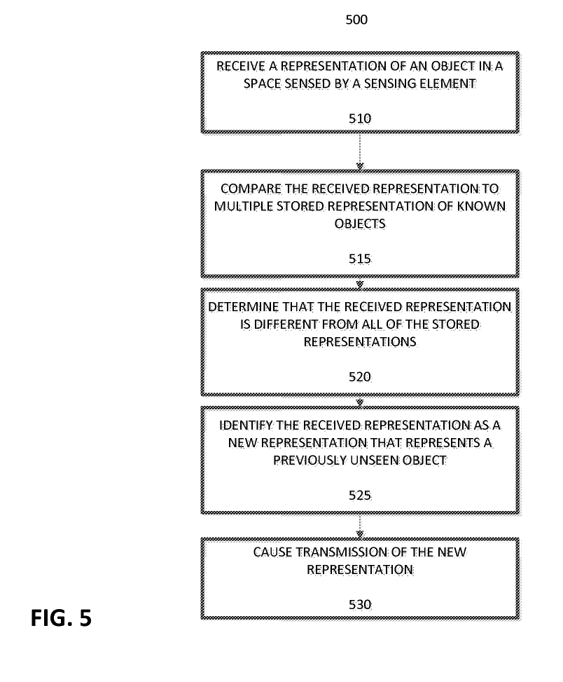

The data site 450 may be a remote data site that is physically separate from the device 405 but in data communication with the device 405. The data site 450 receives data (such as the signature 125) from the device 405 and provides the received data to other devices (not shown). The data site 450 also may provide data (such as signatures from other devices) to the device 405. The data site 450 may include a website or other graphical interface and/or a display to allow a human operator to more easily review and/or visualize data stored on the data site 450. The device 405 also may include a display or may be in communication with a display (not shown) that allows an operator to visualize data collected by the device 405. FIG. 5 shows an example process 500 for real-time signature identification and distribution. The process 500 may be performed by one or more processors included in a system such as the systems 100, 200, 300 or the device 400 discussed above.

A representation of an object in a space sensed by the sensing element 105 is received (510). The object in the space may be the object 120. The object in the space is detected by the sensing element 105 and may be referred to as the “detected object.” The representation may be used to determine a signature associated with the detected object. For example, in implementations in which the sensing element 105 includes a CWMD, amplitude and frequency vectors may be extracted from the data collected by the CWMD and used to generate a signature of the object 120. The representation of the detected object is compared to multiple representations, each of which is associated with a particular known threat object (515). For example, the multiple representations may include signatures of buried land mines, firing pins, and bomb detonators.

The representation of the detected object is determined to be different from each representation of the stored multiple representations (520). Based on the determination that the representation of the detected object is different from all of the stored representations, the representation is identified as a new representation (525). In other words, the object in the space (the object detected by the sensing element 105) is deemed to be a previously unknown or not-previously-encountered object because the signature of the object does not match any of the signatures of objects that the system has previously encountered. Transmission of the new representation is caused (530). For example, the communications interface 115 may transmit the new representation to the data site 135 so that the new representation may be distributed to other detection systems or screening systems.

In some implementations, an alarm, alert, or other indicator, may be produced when it is determined that the representation is of a previously unknown object. The alarm may be visual, in the form of a message, and/or audible. For example, the device 405 may produce an alarm for display on the device 405, for presentation on a display that is in communication with the device 405, and/or for presentation at the data site 450.

In some implementations, for example when the detected signature is an x-ray or infrared image, a user (such as an operator) associated with the detection system may analyze the representation and determine that the detected object is different from other known threat object representations. Accordingly, the user may initiate distribution of the previously unknown or previously encountered signature to other detection systems through the communications interface. In some implementations, the distribution of the previously unknown signature may be initiated by an automated process with or without intervention by the user.

In some implementations, the new representation is processed further with an electronic processor and the detected object is determined to be a threat object based on the further processing. In some implementations, the detected object is physically examined and determined to be a threat object before the signature is provided through the communications interface 115. In some implementations, the data site 135 may provide a new representation detected by another detection or screening system to the system 100 through the communications interface 115.

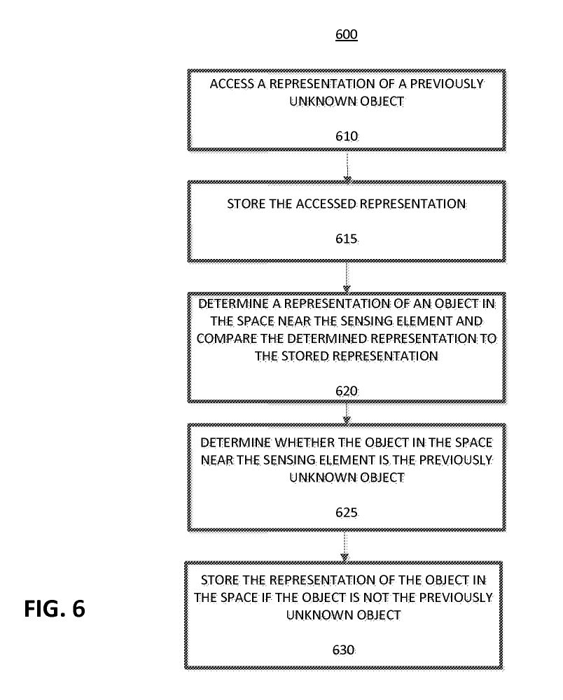

FIG. 6 shows an example process 600 for real-time signature distribution. The process 500 may be performed by one or more processors included in a system such as the systems 100, 200, 300 or the device 400 discussed above.

A representation of a previously unknown object is accessed through a communications interface (610). For example, the system 100 may download, from the data site 135 and through the communications interface 115, a signature representing a new threat object detected by the system 300 and provided to the data site 135 by the system 300. The system 100 may download the signature of the new threat in response to receiving a notification from the data site 135 that a new signature has been detected by another detection system or another screening system. The representation of the previously unknown object is stored by the system 100 (615).

Meanwhile, the system 100 continues to scan the space around the sensing element 105 and collects data representing the environment around the sensing element 105. A representation of an object in a space near the system 100 is determined and compared to the representation of the previously unknown object (620). Whether the object in the space (the “detected object”) is the new threat object is determined by comparing the representation of the detected object to the representation of the previously unknown object (625). If the detected object is not the new threat object, the representation of the detected object is stored (630).

In some implementations, if the detected object is not the new threat object, the representation of the object in the space is further processed to determine if the object in the space is a yet another new threat object. If the object in the space is another new threat object, the representation of the object in the space is provided to the data site 135 for use by other sensing or screening systems.

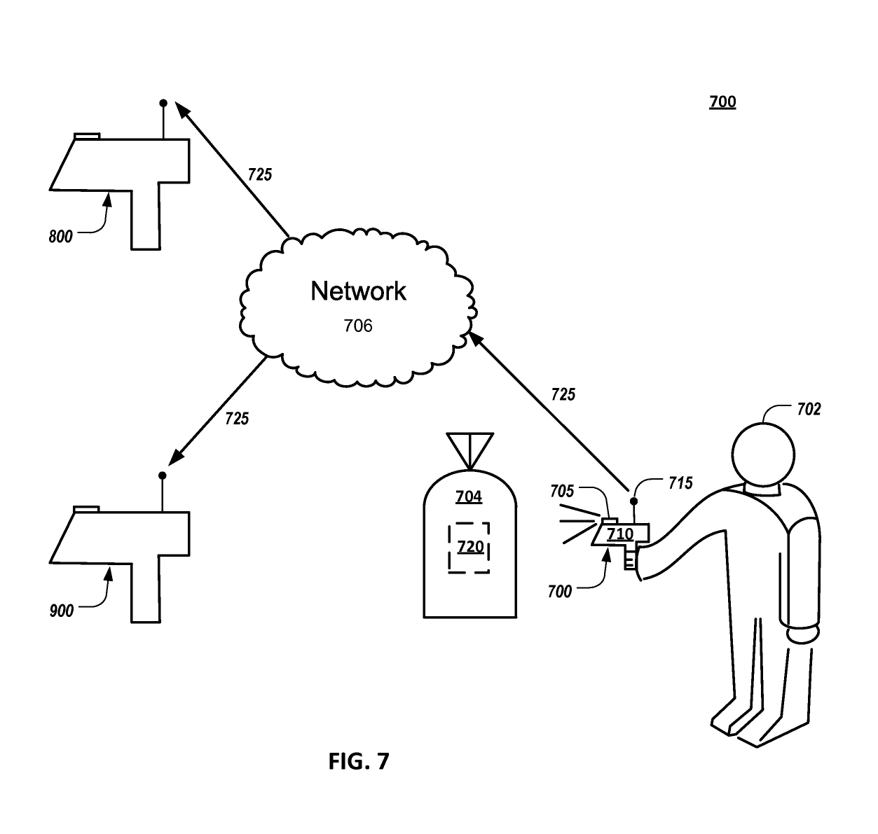

FIG. 7 shows a hand-held system for detecting objects. The system 700 includes a sensing element 705 attached to a hand-held platform 710. The system 700 also includes a communications interface 715, which may be secured to the platform 710. In the example shown, a user 702 positions the sensing element 705 near a container 704 that houses a previously unknown or never-before-detected threat object 720. As described above, the sensing element 705 detects the object 720, and the system 700 determines a signature 725 of the detected object 720 based on data from the sensing element 705. In this example, the system 700 transmits the signature 725 to remote detection systems 800 and 900, through a communications network 706. In some examples, the system 700 may communicate the signature 725 to one of the systems 800 or 900, and the system receiving the signature 725 communicates the signature 725 to the other of the systems 800 or 900. The hand-held system 700 may include any appropriate type of sensor, such as a radar or an infrared sensor. In some examples, the hand-held system 700 includes a combination of such sensors. For example, the sensor 700 may include a ground-penetrating radar and a metal detector (CWMD or pulsed).

The communications network 706 may include a large computer network, examples of which include a local area network (LAN), wide area network (WAN), the Internet, a cellular network, or a combination thereof connecting a number of detection systems, fixed computing devices, and/or server systems. The communications network 706 may provide for communications under various modes or protocols, examples of which include Transmission Control Protocol/Internet Protocol (TCP/IP), Global System for Mobile communication (GSM) voice calls, Short Electronic message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. Communication may occur through a radio-frequency transceiver. In addition, short-range communication may occur, for example, using a BLUETOOTH, WiFi, or other such transceiver system.

In some implementations, the communications interface 715 is operable to directly access the communications network 706. The communications interface 715 also may be compatible with a suitable computing device, for example, a desktop computer, a laptop or tablet computer, and/or a mobile phone. The computing device may be used to download the signature 725 from the system 700, and to distribute the signature 725 through the network to the systems 800 and 900.

A number of implementations have been described. Nevertheless, it will be understood that various modifications may be made without departing from the scope of the disclosure.

What is claimed is:

1. A device comprising:
a sensing element configured to produce a representation of an object in a space near the sensing element;
an electronic storage comprising multiple representations, each representation being associated with a particular object;
a communications interface; and
a processor operable to:
receive the representation of the object in the space from the sensing element,
compare the representation of the object in the space to the multiple representations stored in the electronic storage,
determine that the representation of the object in the space is different from all of the multiple representations based on the comparison,
identify the representation as a new representation based on the determination, and
cause the new representation to be available to a data site through the communications interface.

2. The device of claim 1, wherein each of the multiple representations is a signature of a particular hazardous object.

3. The device of claim 2, wherein each of the signatures uniquely identifies the particular hazardous object.

4. The device of claim 2, wherein the sensing element is configured to detect metallic objects.

5. The device of claim 2, wherein the sensing element comprises a radar.

6. The device of claim 1, wherein the sensing element comprises multiple sensing elements.

7. The device of claim 6, wherein each of the multiple sensing elements is a different type of sensing element.

8. The device of claim 7, wherein the multiple sensing elements comprise a ground penetrating radar and a sensor configured to detect metallic objects.

9. The device of claim 1, wherein the sensing element is mounted in a fixed screening portal.

10. The device of claim 9, wherein the sensing element is configured to detect metallic objects hidden on an item moving through the portal, the item being one or more of a person or a package.

11. The device of claim 1, wherein the sensing element is mounted on a movable platform.

12. The device of claim 1, wherein the sensing element is mounted on a hand-held platform.

13. The device of claim 1, wherein the processor is further operable to identify the new representation as a signature of a previously unknown hazardous object.

14. The device of claim 1, wherein the processor is further operable to:
access a representation of a previously unknown object from the data site through the communications interface;
store the representation of the previously unknown object in the electronic storage,
compare the representation of the object in the space to the representation of the previously unknown object,
determine whether the object in the space is the previously unknown object based on the comparison, and
store the representation of the object in the electronic storage if the object in the space is not the previously unknown object.

15. A device comprising:
a sensing element configured to produce a representation of an object in a space near the sensing element;
an electronic storage;
a communications interface; and
a processor operable to:
access a representation of a previously unknown object from a data site through the communications interface,
store the representation of the previously unknown object in the electronic storage,
compare the representation of the object in the space to the representation of the previously unknown object,
determine whether the object in the space is the previously unknown object based on the comparison, and
store the representation of the object in the electronic storage if the object in the space is not the previously unknown object.

16. The device of claim 15, wherein the processor is further operable to detect a notification indicating that a previously unknown object has been identified and that a representation of the previously unknown object is available from the data site, and the processor accesses the representation of the previously unknown object from the data site through the communications interface in response to detecting the notification.

17. The device of claim 15, further comprising an indicator that presents an alarm if the object in the space is the previously unknown object.

18. The device of claim 15, wherein the processor is further operable to:
determine that the representation of the object in the space is different from all stored multiple representations based on the comparison,
identify the representation of the object in the space as a new representation based on the determination, and
cause transmission of the new representation through the communications interface.

19. A computer-readable storage medium storing instructions, that when executed, cause a processor to perform the following operations:
receive a signature from a device, the signature being identified as being a representation of a previously unknown object by the device;
store the signature received from the device;
generate a notification indicating that a signature of a previously unknown object is available; and
provide the signature to a notified device in response to receiving a request from the notified device.

20. The medium of claim 19, wherein the device and the notified device are two different types of detectors.

21. The medium of claim 19, wherein the device and the notified device each comprise a different type of detector.

22. The medium of claim 19, wherein the instructions further cause the processor to display a user interface that allows visualization of stored signatures.
